(19) United States
(12) Patent Application Publication
(10) Pub. No.: US 2018/0018849 A1
(43) Pub. Date: Jan. 18, 2018

(54) Vending Machine For Heated Food Products And Cup For Use In The Vending Machine

(71) Applicant: Bistrotec Holding B.V., Den Haag (NL)

(72) Inventors: Geert-Jon Willem Jepkes, 's-Gravenhage (NL); Eugene Julien Bastiaan Van Zon, Voorburg (NL)

(21) Appl. No.: 15/548,873

(22) PCT Filed: Feb. 10, 2016
(86) PCT No.: PCT/NL2016/050096

§ 371 Date: Aug. 4, 2017

(30) Foreign Application Priority Data
Feb. 12, 2015 (NL) 2014278

(51) Int. Cl. G07F 9/10; G07F 11/10; G07F 17/00; H05B 6/80

(52) U.S. Cl. CPC G07F 9/105; H05B 6/808; G07F 11/10; G07F 17/0078

(57) ABSTRACT

The invention relates to a vending machine for heated food products, wherein the vending machine is provided with a storage device for packaged food products, selection device for selecting a food product, first transport means for displacing a chosen food product from the storage device to a first transport position, second transport means for transferring the chosen food product from the first transport position to a heating device including a microwave oven, which microwave oven is provided with an oven space, automatic operating means for operating the microwave oven, and third transport means for displacing the heated food product from the microwave oven to a take-out device. The invention also relates to a heating device comprising a microwave oven for application in the vending machine or as a stand-alone heating device.

The invention relates to a vending machine for heated food products, wherein the vending machine is provided with
a storage device for packaged food products,
a selection device for selecting a food product,
first transport means for displacing a chosen food product from the storage device to a first transport position,
second transport means for transferring the chosen food product from the first transport position to a heating device comprising a microwave oven, which microwave oven is provided with an oven space,
automatic operating means for operating the microwave oven, and
third transport means for displacing the heated food product from the microwave oven to a take-out device.

A vending machine according to the preamble is known in the field and is described in the European patent EP1688894.

Another known vending machine according to the preamble is described in the American patent U.S. Pat. No. 3,397,817.

The known vending machine has the drawback that, for the purpose of placing the food product in the microwave oven and taking the food product out of the microwave oven, the vending machine is provided with displacing means which are driven by one or more motors. The known vending machine is hereby expensive and susceptible to malfunction.

The invention has for its object to provide a vending machine according to the preamble, wherein no displacing means are necessary for placing and taking the food product in and out of the microwave oven.

The invention provides for this purpose a vending machine according to the preamble, characterized in that the oven space is provided with
an entrance which can be closed to microwaves by means of first closing means and
an exit which can be closed to microwaves by means of second closing means,
wherein the entrance is located above the exit and the entrance and the exit are located in opposite sides of the oven space,
a transport space which forms the third transport means and is optionally formed by a cover of microwave-permeable material, which runs through the oven space and extends between the entrance and the exit,
   and wherein the microwave oven is provided with
positioning means for gripping and holding in position the food product at a chosen location in the transport space during operation of the microwave oven.

With these technical measures the chosen food product can be displaced via the entrance to the transport space by the force of gravity, following which the positioning means hold the food product in position in the microwave oven. After preparation of the food product, the food product can be displaced to the take-out device by the force of gravity.

The transport space is preferably tubular. The chance of a food product getting stuck in the transport space is hereby greatly reduced.

In a preferred embodiment of the vending machine according to the invention the positioning means comprise at least two co-acting arms of microwave-permeable material which are displaceable between a first and a second position, wherein in the first position first outer ends of the arms are placed close together and a receiving space is formed between the first outer ends for receiving the food product at the chosen location, in the second position the first outer ends of the arms are placed apart and release the food product, the second outer ends of the arms are placed outside the oven space and the vending machine is provided with drive means outside the oven space for displacing the arms from the first to the second position and vice versa by engaging on the second outer ends of the arms.

These technical measures make it possible to position the food product in the transport space and in the oven space during operation of the microwave oven, wherein the positioning means remain partially in the microwave oven without the positioning means affecting the operation of the microwave oven.

In a further development of the preferred embodiment of the vending machine according to the invention the first arm and second arm are configured to grip a cup-like container with a closed upper side. The vending machine is hereby highly suitable for heating liquid food products, such as for instance soups.

In another further development of the preferred embodiment of the vending machine the drive means are also configured to shake the food product during operation of the microwave oven. It is hereby possible to shake the liquid food products in the cup-like holder, whereby a better heating takes place. This is particularly important when heating soups. Soup is generally heated to about 70 degrees. During heating of the soup in the closed container a pressure build-up takes place in the container as a result of vapour pressure. The sealed container is normally resistant to a vapour pressure which occurs at a maximum of 80 degrees (approximately 500 hPa). For reasons of hygiene a choice has been made not to perforate the container before heating.

Tests have shown that the vapour pressure in the container becomes much higher during heating than the vapour pressure expected at 70 degrees, whereby the sealed edge of the container comes loose. The explanation for this lies in the fact that the microwave oven does not heat the soup uniformly. The soup along the outside becomes much hotter because the microwave radiation reaches about 6 mm into the soup. The convection in the soup is too low to ensure a uniform heating. Tests have further shown that the soup at the edge of the container will begin to boil very quickly during heating (due to the high power of the microwave oven). The pressure in the container hereby rises to a higher value than the pressure expected at 70 degrees. The shaking mechanism ensures that the liquid is in motion during heating. A homogenous heating of the liquid is hereby achieved, and the pressure remains limited.

For the purpose of shaking the food product each drive means is connected to a second outer end of an arm by means of a crankshaft. Owing to the crankshaft each arm can perform a translation in advantageous manner, wherein the stroke of the translation is limited to the length of the crank.

In order to clamp the food product in the arms during shaking the at least two co-acting arms are displaceable between a first and a third position, wherein in the third position the first outer ends of the arms are placed in such proximity that the food product is fixedly clamped in the arms.

In addition, the invention relates to a cup for use in the vending machine according to the invention. The cup according to the invention has the feature that the cup comprises a recess arranged around the outer side of the cup, wherein the recess is intended to receive the first outer ends of the first arm and second arm. The recess makes it possible for the vending machine to vigorously shake the cup without the cup becoming detached from the positioning means.

The application also relates to a heating device comprising a microwave oven, this microwave oven being provided with an oven space, which oven space is provided with
an entrance which can be closed to microwaves by means of first closing means and
an exit which can be closed to microwaves by means of second closing means,
wherein the entrance is located above the exit and the entrance and the exit are located in opposite sides of the oven space,
a transport space which forms the third transport means and which runs through the oven space and extends between the entrance and the exit, and wherein the microwave oven is provided with
positioning means for gripping and holding in position the food product at a chosen location in the transport space during operation of the microwave oven.

The invention will be further elucidated with reference to the following figures, in which:

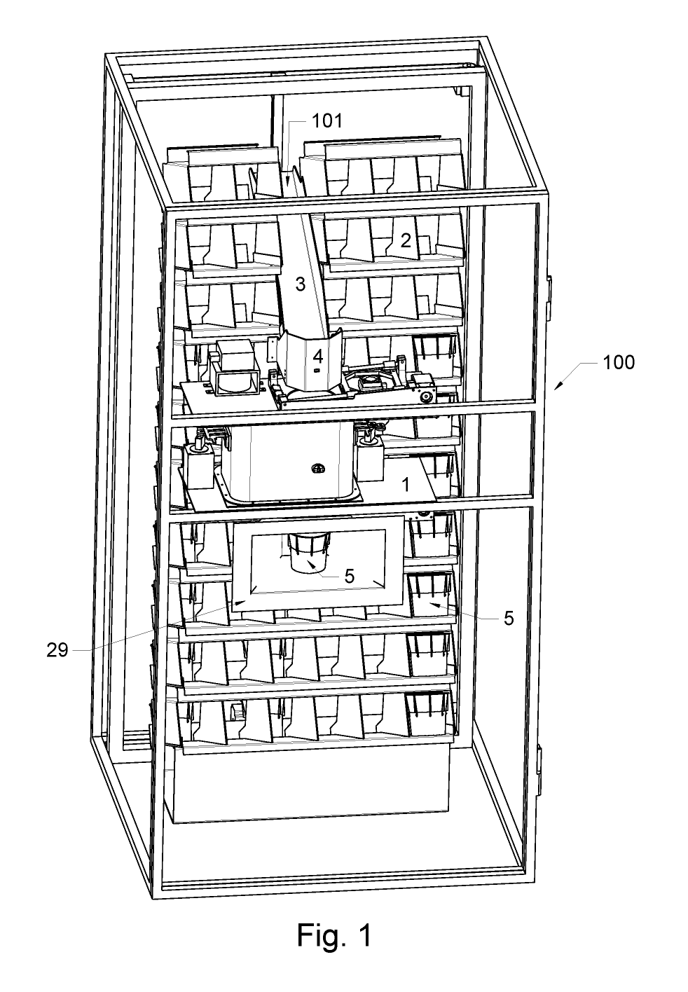

FIG. 1 shows a front view of a preferred embodiment of the vending machine according to the invention;

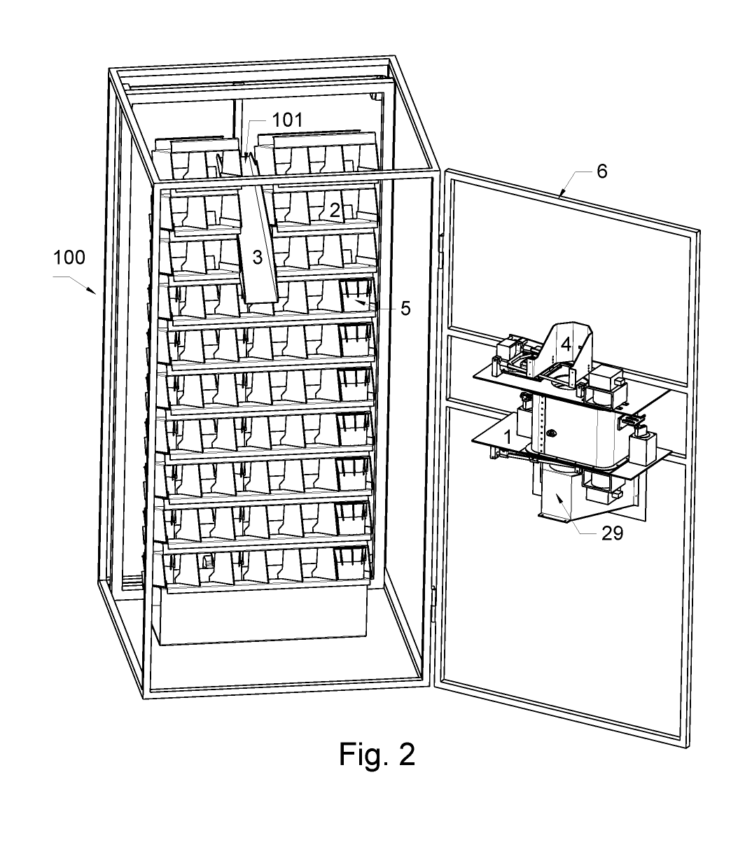

FIG. 2 shows a front view of the vending machine according to FIG. 1 with opened door;

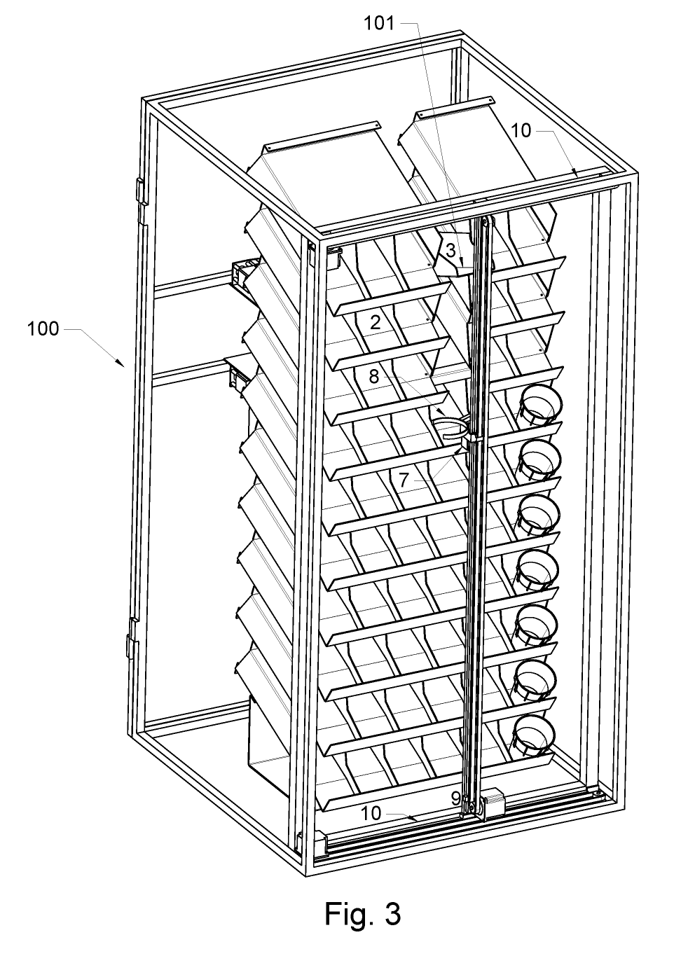

FIG. 3 shows a rear view of the vending machine according to FIG. 1;

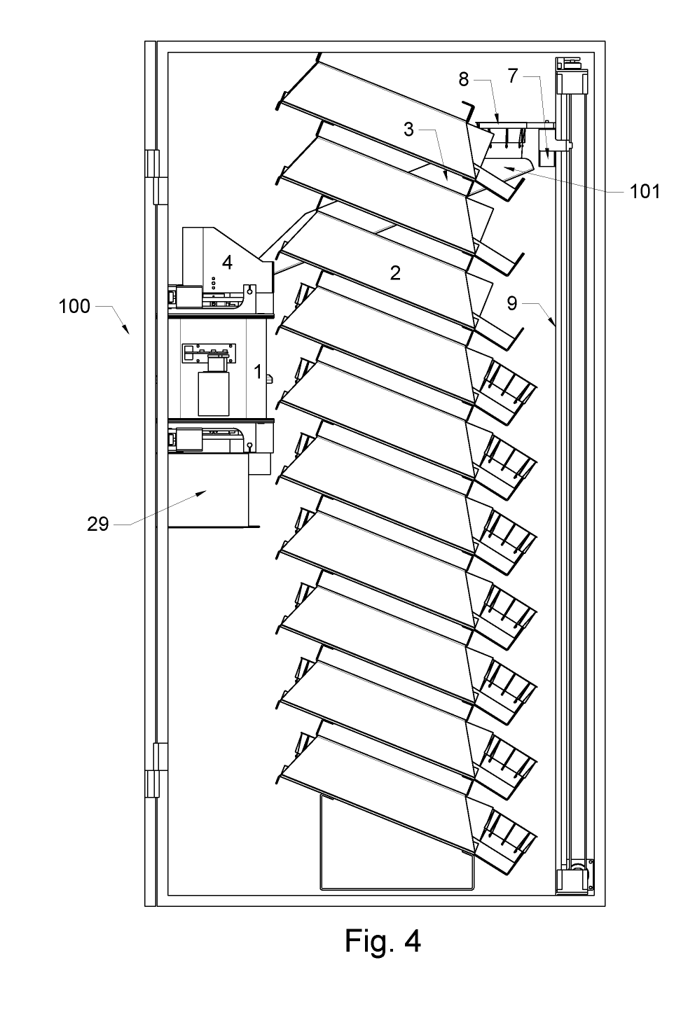

FIG. 4 shows a side view of the vending machine according to FIG. 1;

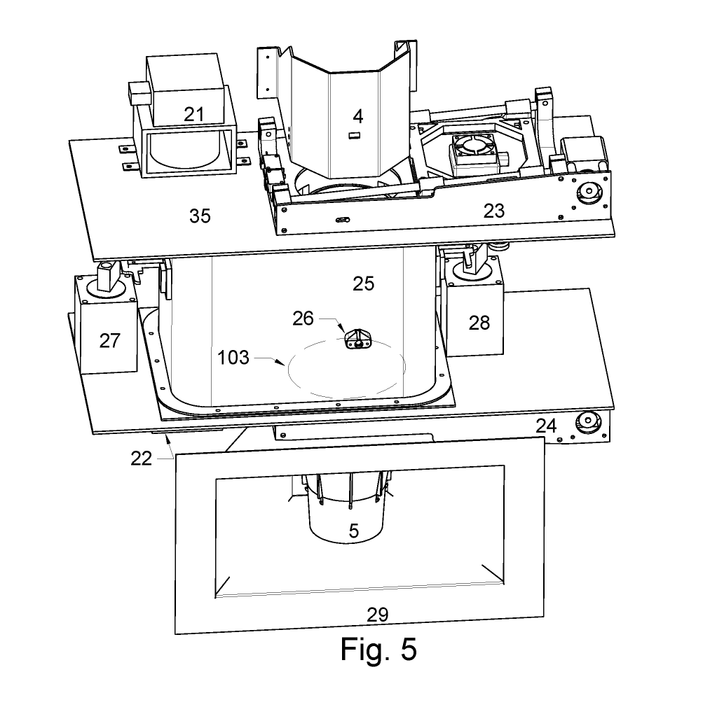

FIG. 5 shows the cup catcher, the heating device and the take-out device of a preferred embodiment of the vending machine according to the invention;

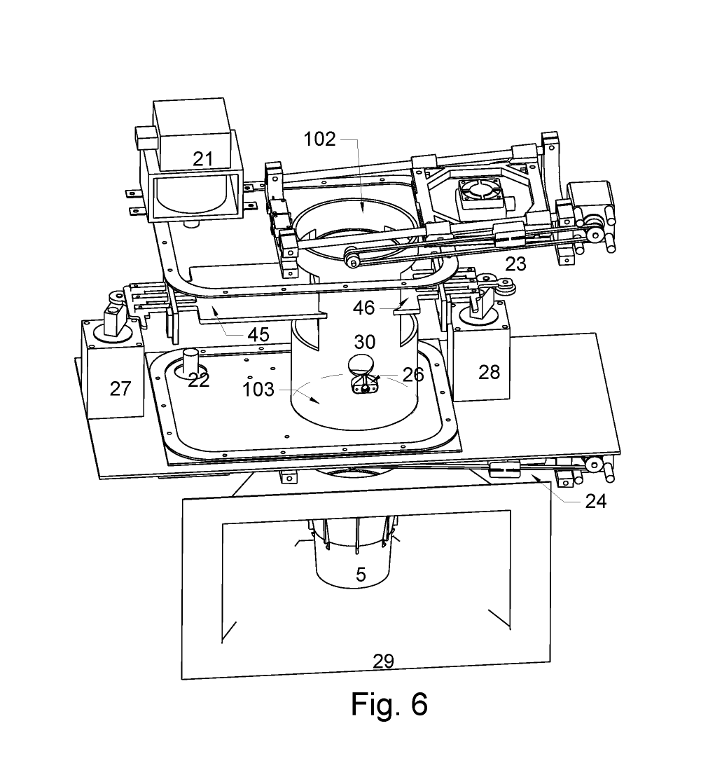

FIG. 6 shows the heating device and take-out device according to FIG. 5;

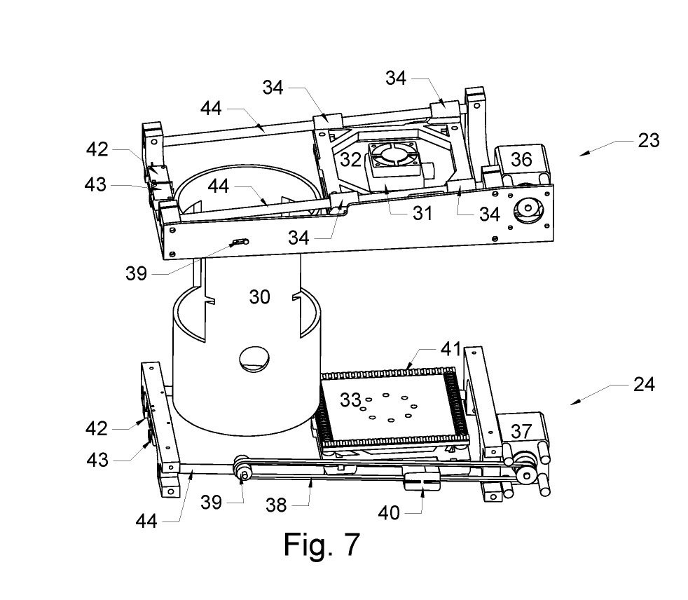

FIG. 7 shows only the first and second closing means and the third transport means of the heating device according to FIG. 6;

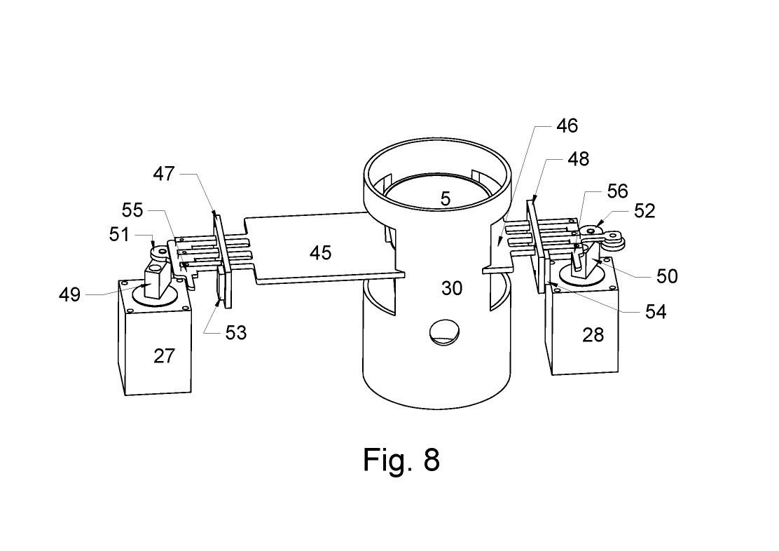

FIG. 8 shows the third transport means and the positioning means;

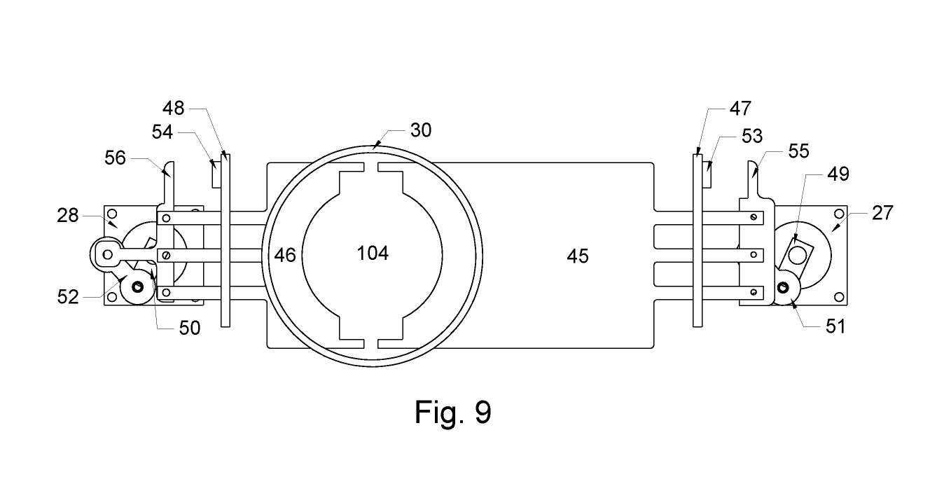

FIG. 9 shows the shaking mechanism without a cup being loaded;

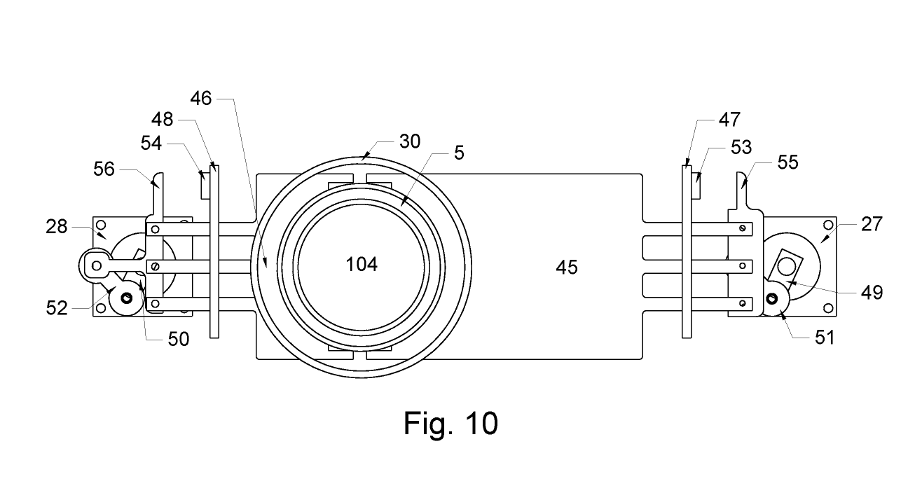

FIG. 10 shows the shaking mechanism in which the cup is held in position by the positioning means;

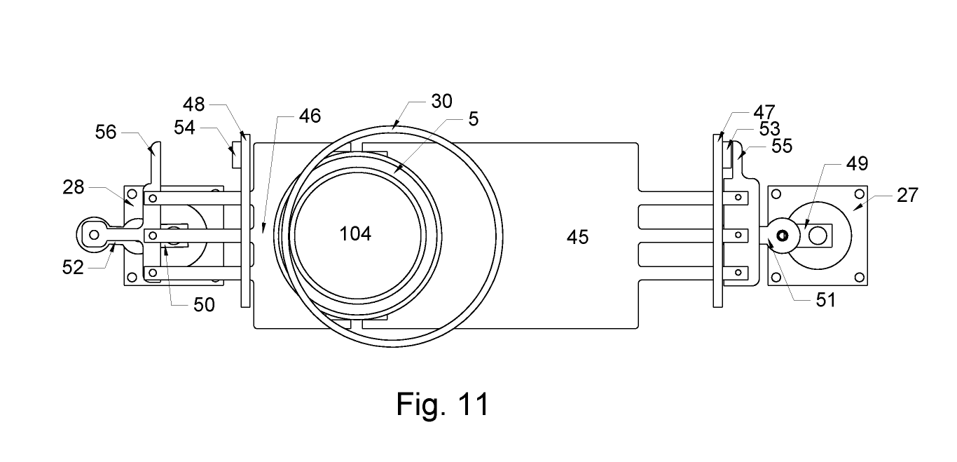

FIG. 11 shows the shaking movement of the cup to the left;

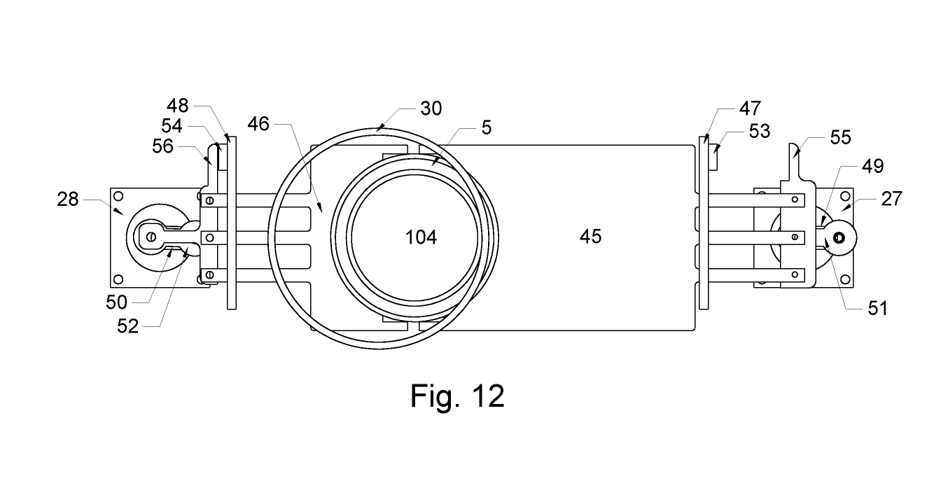

FIG. 12 shows the shaking movement to the right;

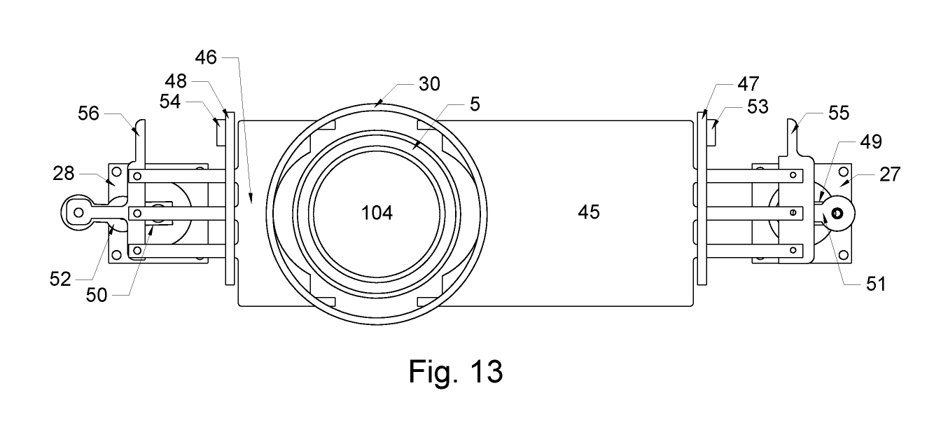

FIG. 13 shows the ejecting of the cup;

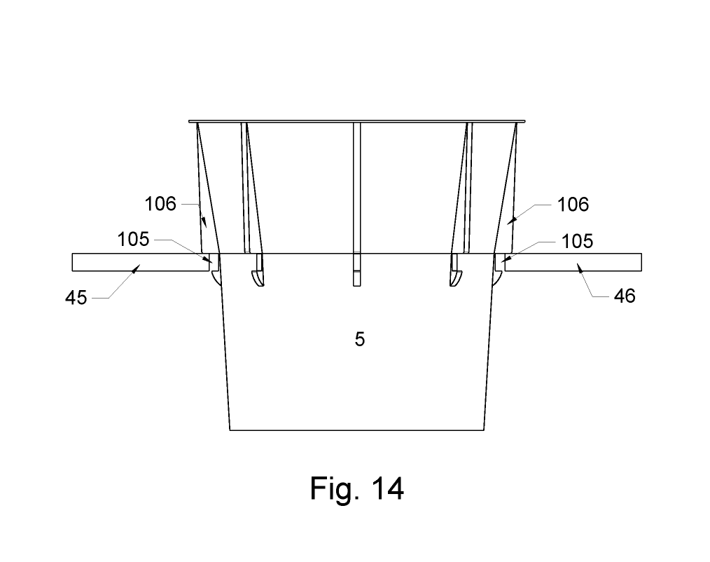

FIG. 14 shows the cup with the positioning means in the second position;

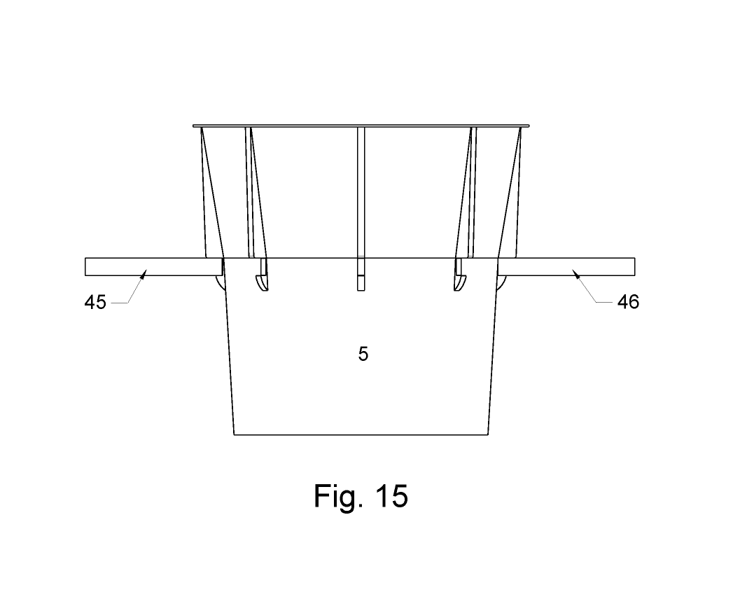

FIG. 15 shows the cup with the positioning means in the third position;

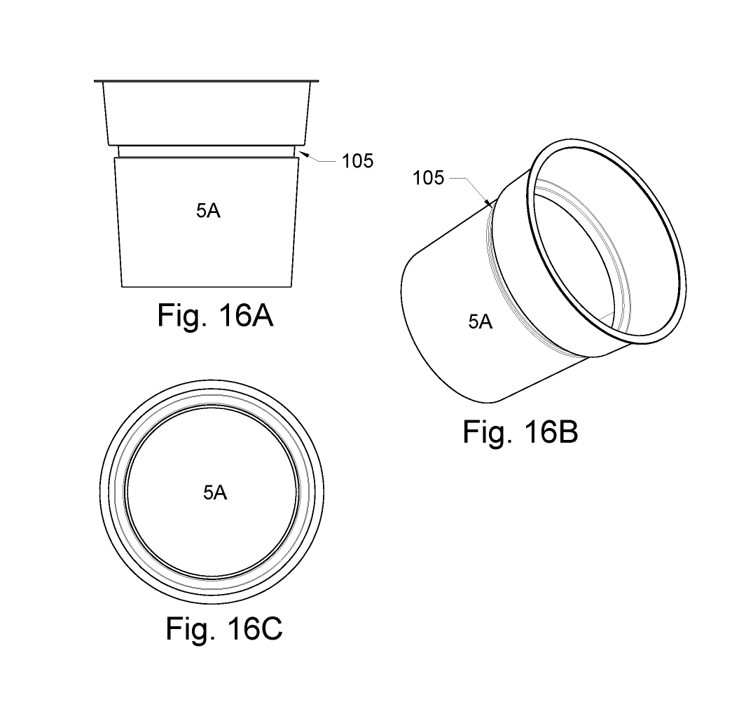

FIGS. 16A, 16B and 16C show respectively a side view, isometric view and a top view of a first embodiment of the cup according to the invention;

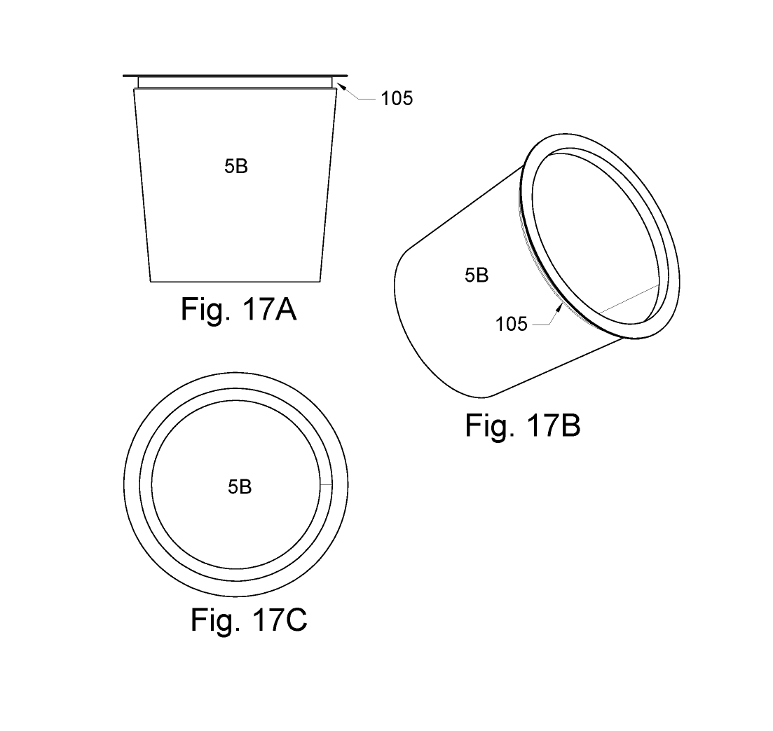

FIGS. 17A, 17B and 17C show respectively a side view, isometric view and a top view of a second embodiment of the cup according to the invention;

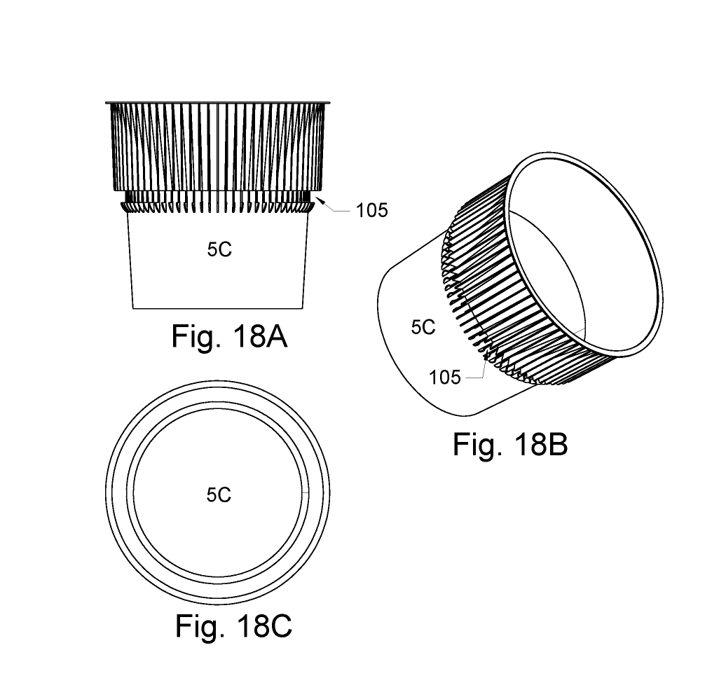

FIGS. 18A, 18B and 18C show respectively a side view, isometric view and a top view of a third embodiment of the cup according to the invention.

The same reference numerals designate the same components in the different figures.

The operation of the vending machine will be explained in the figures by embodying the vending machine as a vending machine for heated soup. The vending machine according to the invention can however also heat other food products by means of adjusting the relevant parts to the form of the other food product.

The different figures show a vending machine according to the invention, wherein the vending machine is configured to sell soup, wherein the soup is packaged in a cup, preferably of polypropylene or C-PET, provided with a top seal.

The vending machine consists of three main components: the storage device, the transport of the packaged food from the storage device, and the heating device, which comprises substantially a microwave oven.

FIG. 1 shows a front view of a preferred embodiment of vending machine 100 according to the invention. The left side wall, the top and the front take a transparent form for the purpose of illustration. Vending machine 100 is configured to sell heated soups. A user can select a cup 5 of soup using a selection device (not shown) which is embodied with known means. The selection device is preferably located on the front side of vending machine 100. Heating device 1 is located on the front side of vending machine 100. Storage device 2, which is (partially) filled with cups 5, is located behind heating device 1. Located on the rear side of vending machine 100 are the first transport means (see FIG. 3), which are configured to transport a selected cup 5 to a first transport position 101, the location of which is on the upper side of storage device 2. The second transport means, which comprise substantially a slide track 3 and a connecting cup catcher 4, are placed connecting to transport position 101. From transport position 101 a selected cup 5 drops via cup catcher 4 into heating device 1 by means of slide track 3. Cup catcher 4 guides cup 5 to entrance 102 of heating device 1 here. Following heating of the soup, cup 5 moves by means of third transport means from heating device 1 to a take-out device 29, after which a user can take the heated soup out of vending machine 100.

FIG. 2 shows a front view of vending machine 100 according to FIG. 1 with opened door 6. Heating device 1, cup catcher 4 and take-out device 29 are mounted in door 6. Storage device 2 can hereby be easily filled as soon as door 6 is opened.

FIG. 3 shows a rear view of vending machine 100 according to FIG. 1. Situated on the rear side of storage device 2 are the first transport means, which are configured to select a cup 5 from storage device 2 and for transport of selected cup 5 to the first transport position 101 via slide track 3. The first transport means comprise a rotating cup gripper 8 which can move along a vertical shaft 9 and horizontal shaft 10.

FIG. 4 shows a side view of vending machine 100 according to FIG. 1. Storage device 2 comprises different levels which run obliquely downwardly in the direction of the rear side of vending machine 100 and are preferably placed at an angle relative to the horizontal of between 20 and 25 degrees, more particularly 22 degrees. A cup 5 which is placed on the front side of storage device 2 will hereby slide to the lowest available point.

FIG. 5 shows cup catcher 4, heating device 1 and take-out device 29 of a preferred embodiment of vending machine 100 according to the invention. Cup catcher 4 is situated above an entrance 102 of heating device 1. Entrance 102 comprises first closing means 23 for closing entrance 102 of oven space 25 to microwaves. Heating device 1 also comprises an exit 103 provided with second closing means 24 for closing exit 103 to microwaves. Entrance 102 is located above exit 103. After cup 5 has been placed in oven space 25 via cup catcher 4 and entrance 102, cup 5 will be guided from oven space 25, via exit 103 and to take-out device 29 by means of the third transport means after the contents of the cup have been heated. Heating device 1 also comprises a first drive means 27 and a second drive means 28, the operation of which will be further elucidated in FIG. 6. Heating device 1 also comprises an optical sensor 26 for detecting a cup 5.

FIG. 6 shows heating device 1 and take-out device 29 according to FIG. 5. The walls of oven space 25 have been made transparent by way of illustration, so that components in oven space 25 become visible. The third transport means are formed by a transport space formed by a cover 30 of microwave-permeable material which runs through oven space 25 and extends between entrance 102 and exit 103. The transport space (and cover 30) is preferably tubular and has a diameter greater than cup 5.

The transport space is substantially vertical, wherein entrance 102 is located above exit 103.

Heating device 1 is provided with positioning means for gripping and holding in position cup 5 at a chosen location in the transport space during operation of the microwave oven. The positioning means comprise two co-acting arms 45, 46 which are linearly displaceable in a substantially horizontal plane between a first and a second position.

In the first position the first outer ends of arms 45, 46 are placed close together. In this position a receiving space 104 is formed between the first outer ends for the purpose of receiving cup 5.

In the second position the first outer ends of arms 45, 46 are placed apart and release cup 5.

The second outer ends of arms 45, 46 are placed outside oven space 25. Vending machine 100 is provided with first and second drive means 27, 28 for displacing arms 45, 46 from the first position to the second position and vice versa. The first and second drive means 27, 28 are preferably embodied as stepping motor. The first and second drive means 27, 28 are connected via a first and second crankshaft 49, 50 to respectively the first and second arm 45, 46. These first and second crankshafts 49, 50 convert the rotation of the shaft of both the first and second drive means 27, 28 into translation of respectively the first and second arm.

Drive means 27, 28 are also configured to shake the food product during operation of the microwave oven. The control of drive means 27, 28 is for this purpose such that both the first and the second arm move in the same direction and hold the first outer ends of the arms in the first position during this movement.

FIG. 7 shows only the first and second closing means 23, 24 and the third transport means of heating device 1 according to FIG. 6. The first closing means 23 comprise a first valve mechanism. The second closing means 24 comprise a second valve mechanism. The second valve mechanism is preferably a mirror-symmetrical copy of the first valve mechanism, apart from one component: sensor unit 31. Sensor unit 31 comprises a fan, a temperature sensor and a humidity sensor. During heating of cup 5 air is drawn via the holes in valves 32, 33 from oven space 25 by the fan and the process is monitored by comparing the measured temperature and humidity values to reference values. Valves 32, 33 are guided along a linear guide 44, which is placed at an angle of 5° to the horizontal, with linear ball bearings 34. Valves 32, 33 are advanced by motors 36, 37, toothed belt 38 and a timing pulley 39. Valve 33 is attached to toothed belt 38 with belt coupling 40.

Valves 32, 33 move parallel to the horizontal, but because guide 44 of valves 32, 33 is placed at a small angle a vertical force is exerted on the upper plate (35, see FIG. 5) of oven space 25 during closing of valves 32, 33. A well-conducting contact is hereby brought about via the resilient contact fingers 41, and the electromagnetic field created during operation of the first and second microwaves 21 remains in oven space 25.

Switch 42 is intended for calibration of the valve movement and detection of an open valve 32 in the control software. Switch 43 is a hardwired safety circuit which ensures that first and second microwaves 21 will not operate when the first valve mechanism and/or the second valve mechanism is not closed.

FIG. 8 shows the third transport means and the positioning means. Cup 5 is clamped between first arm 45 and second arm 46 by way of illustration. These arms 45, 46 are guided through the wall of oven space 25 via two guide plates 47, 48. Arms 45, 46 are moved by stepping motors 27, 28 via two crankshafts 49, 50 and drive rods 51, 52. Because the movement of arms 45, 46 is bounded by guide plates 47, 48 and cover 30, arms 45, 46 can only translate over the same horizontal axis. The movement is calibrated with two inductive switches 53, 54 which are activated by the metal parts 55, 56 which are connected to arms 45, 46.

FIGS. 9-14 show the operation of the shaking mechanism. These figures show the upper side of the shaking mechanism as shown in FIG. 8.

FIG. 9 shows the shaking mechanism without a cup 5 being loaded. The first outer ends of arms 45, 46 are in the first position, whereby a cup 5 which is supplied via the transport space gets caught between first arm 45 and second arm 46 in receiving space 104.

FIG. 10 shows the shaking mechanism in which cup 5 is held in position by the positioning means.

FIG. 11 shows the shaking movement of cup 5 to the left.

FIG. 12 shows the shaking movement to the right.

FIG. 13 shows the ejecting of cup 5;

FIG. 14 shows cup 5 with the positioning means in the second position. In the second position cup 5 is held in position by the positioning means via engagement of cup 5 on the upper side of the first outer ends of first and second arms 45, 46.

FIG. 15 shows cup 5 with the positioning means in the third position.

In the third position cup 5 is also held in position by the positioning means via engagement of cup 5 on the lower side of the first outer ends of first and second arms 45, 46. The third position is particularly important in the shaking of cup 5 during heating.

For the purpose of the third position of the positioning means cup 5 is preferably embodied with a recess 105 arranged around the outer side of cup 5. Cup 5 preferably has elongate fins 106 all the way around. A recess 105 is made on the underside of fins 106. The portion of fin 106 located on the upper side of this recess 105 is wider than the portion of fin 106 on the underside of recess 105.

FIG. 14 shows the moment at which cup 5 is dropped into heating device 1. Cup 5 falls into the circular hole, receiving space 104, which is formed by the two arms 45, 46 and gets caught with the wide portion of fin 106 on the upper side of recess 105. Optical sensor 26 (see FIGS. 5 and 6) detects cup 5 and moves the first outer ends of arms 45, 46 slightly toward each other, so that cup 5 is fixed by the lower and upper side of fin 106 at recess 105. Because cup 5 is fixed in arms 45, 46 cup 5 cannot begin to tilt during shaking. The shaking movement is hereby more effective.

If cup 5 gets caught with the lower side on a cup clamp, control software of vending machine 100 ensures a short (preferably 50 milliseconds) reciprocal movement of arms 45, 46 via the absence of a signal from optical sensor 26. Cup 5 hereby falls into place.

FIGS. 16A, 16B and 16C show respectively a side view, isometric view and a top view of a first embodiment of cup 5A according to the invention; FIGS. 17A, 17B and 17C show respectively a side view, isometric view and a top view of a second embodiment of cup 5B according to the invention;

FIGS. 18A, 18B and 18C show respectively a side view, isometric view and a top view of a third embodiment of cup 5C according to the invention.

Cups 5, 5A, 5B and 5C comprise a common recess 105 arranged around the outer side of cup 5, 5A, 5B, 5C, wherein the recess is intended for receiving the first outer ends of first arm 45 and second arm 46.

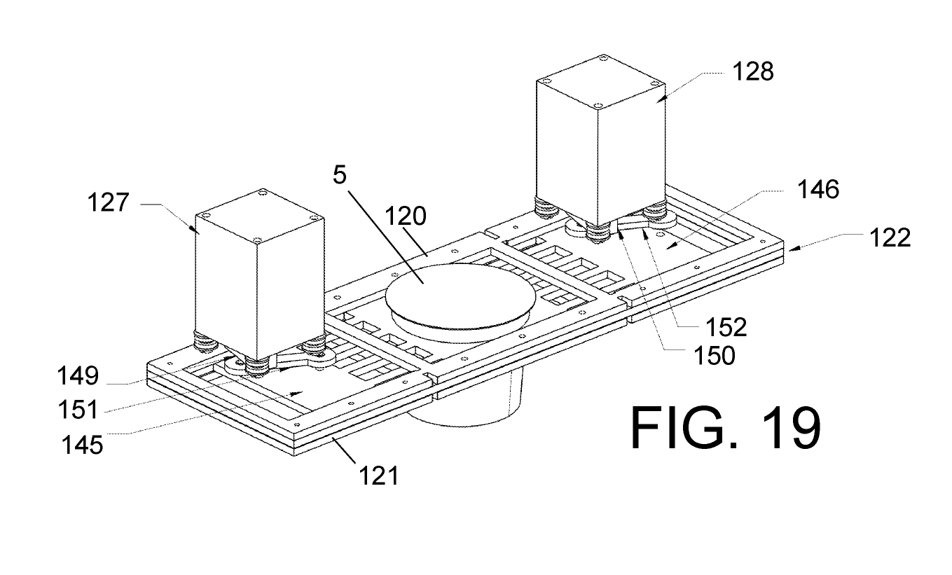

FIG. 19 shows an alternative embodiment of the positioning and shaking means. In this embodiment the third transport means are substantially formed by the substantially vertical channel between entrance 102 and exit 103. The positioning and shaking means consist of two parallel plates 120; 121 situated some distance from each other using plate-like spacer 122 and placed in stationary manner in the heating device, and between which are movable arms 145; 146 of plate-like material. Said plates and arms are preferably manufactured from water jet-cut polyethylene plates. Arm 145 is connected via a crankshaft 149 and drive rod 151 to a drive means 127. Arm 146 is connected via a crankshaft 150 and drive rod 152 to a drive means 128. Arms 145; 146 are on the adjacent side formed such that arms 145; 146 in closed position form a cup holder.

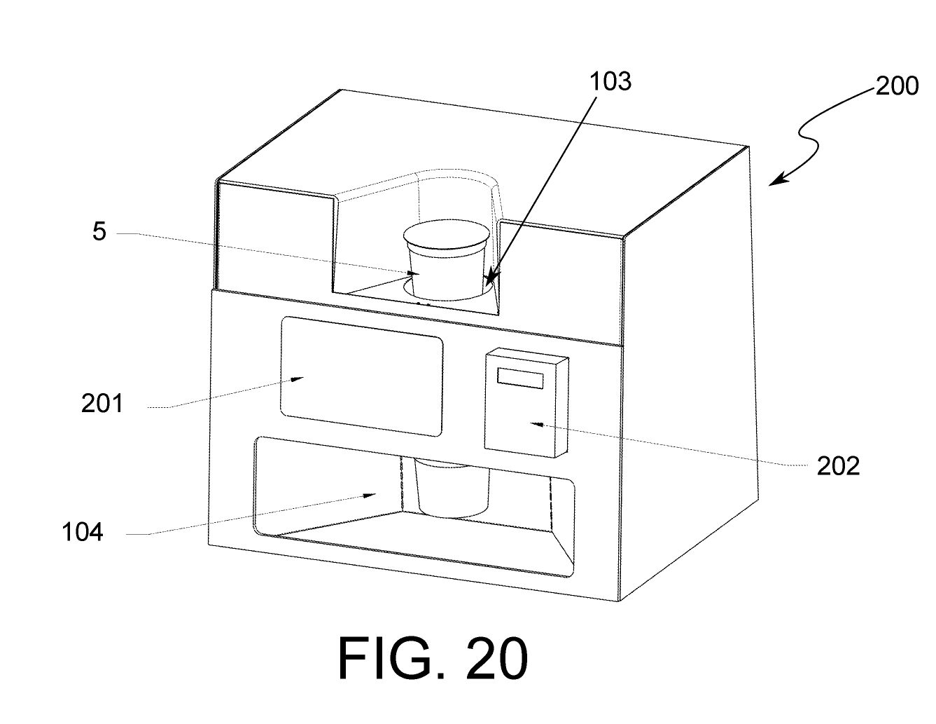

FIG. 20 shows a heating device 200 according to the invention, wherein heating device 200 is intended for stand-alone placing and is configured for direct operation by a user. Heating device 200 comprises a microwave oven, wherein the oven space is provided with an entrance 102 which can be closed to microwaves by means of first closing means and an exit 103 which can be closed to microwaves by means of second closing means. Entrance 102 is located above exit 103 in opposite sides of the oven space. The heating device is provided internally with positioning means and shaking means for gripping and holding in position the food product and shaking at a chosen location in the transport space during operation of the microwave oven. Heating device 200 can be operated via an operating unit 201. The shown commercial embodiment of the heating device also comprises a payment terminal 202.

The invention is expressly not limited to a vending machine 100 for heated soups. Vending machine 100 extends to a vending machine 100 for heated food products, wherein the positioning means are equipped for positioning the chosen food product.

The invention is of course not limited to the described and shown preferred embodiment, but extends to any embodiment falling within the scope of protection as defined in the claims and as seen in the light of the foregoing description and accompanying drawings.

1. Heating device (1, 200) for heating a liquid food product in a cup-like container with a closed upper side, said heating device comprising:
a microwave oven being provided with an oven space (25), provided with
an entrance (102) which can be closed to microwaves by means of first closing means (23) and
an exit (103) which can be closed to microwaves by means of second closing means (24),
wherein the entrance (102) is located above the exit (103), and the entrance (102) and the exit (103) are located in opposite sides of the oven space (25),
a transport space which forms a third transport means and which runs through the oven space (25) and extends between the entrance (102) and the exit (103),
and wherein the microwave oven is provided with positioning means for gripping and holding in position the food product at a chosen location in the transport space during operation of the microwave oven, the positioning means comprise at least two co-acting arms (45, 46) of microwave-permeable material configured to grip the cup-like container, and the at least two co-acting arms are displaceable between a first and a second position, wherein in the first position first outer ends of the arms (45, 46) are placed close together and a receiving space (104) is formed between the first outer ends for receiving the food product at the chosen location, in the second position the first outer ends of the arms (45, 46) are placed apart and release the food product, the second outer ends of the arms (45, 46) are placed outside the oven space (25) and vending machine (100) is provided with drive means (27, 28) for displacing the arms (45, 46) from the first to the second position and vice versa, wherein the drive means (27, 28) are also configured to shake the food product during operation of the microwave oven and a control of the drive means (27, 28) is for this purpose such that both the first and the second arm (45, 46) move in the same direction and hold the first outer ends of the arms (45, 46) in the first position during this movement.

2. Heating device (1, 200) as claimed in claim 1, wherein the transport space is tubular.

3. Heating device (1, 200) as claimed in claim 1, wherein the first arm (45) and second arm (46) are configured to grip the cup-like container.

4. (canceled)

5. Heating device (1, 200) as claimed in claim 1, wherein each drive means (27, 28) is connected to a second outer end of an arm by means of a crankshaft.

6. Heating device (1, 200) as claimed in claim 1 wherein the at least two co-acting arms (45, 46) are displaceable between a first and a third position, wherein in the third position the first outer ends of the arms (45, 46) are placed in such proximity that the food product is fixedly clamped in the arms (45, 46).

7. Heating device (1, 200) as claimed in claim 1, wherein the transport space is formed by a cover (30) of microwave-permeable material which runs through the oven space (25) and extends between the entrance (102) and the exit (103).

8. Heating device (1, 200) as claimed in claim 1, wherein the first closing means (23) and second closing means (24) are each substantially formed by a trapezoidal plate and a collar of the same shape, which are displaceable relative to each other in the same plane.

9. Heating device (1, 200) as claimed in claim 1, wherein the heating device (1, 200) is provided with one or more infrared sensors for measuring the temperature of the food product during heating and shaking thereof.

10. Heating device (1, 200) as claimed in claim 1, wherein the heating device (1, 200) is intended for stand-alone placing and is configured for direct operation by a user.

11. Vending machine (100) for heated food products, wherein the vending machine (100) comprises
storage device (2) for packaged food products,
a selection device for selecting a food product,
first transport means for displacing a chosen food product from the storage device (2) to a first transport position (101),
second transport means for transferring the chosen food product from the first transport position (101) to a heating device (1) comprising a microwave oven, which microwave oven is provided with an oven space (25),
automatic operating means for operating the microwave oven, and
third transport means for displacing the heated food product from the microwave oven to a take-out device (29),
a heating device (1, 200) for heating a liquid food product in a cup-like container with a closed upper side further comprising a microwave oven, this microwave oven being provided with an oven space (25), which oven space (25) is provided with
an entrance (102) which can be closed to microwaves by means of first closing means (23) and
an exit (103) which can be closed to microwaves by means of second closing means (24),
wherein the entrance (102) is located above the exit (103) and the entrance (102) and the exit (103) are located in opposite sides of the oven space (25),
a transport space which forms the third transport means and which runs through the oven space (25) and extends between the entrance (102) and the exit (103),
and wherein the microwave oven is provided with
positioning means for gripping and holding in position the food product at a chosen location in the transport space during operation of the microwave oven,
wherein the positioning means comprise at least two co-acting arms (45, 46) of microwave-permeable material configured to grip the container which are displaceable between a first and a second position, wherein in the first position first outer ends of the arms (45, 46) are placed close together and a receiving space (104) is formed between the first outer ends for receiving the food product at the chosen location, in the second position the first outer ends of the arms (45, 46) are placed apart and release the food product, the second outer ends of the arms (45, 46) are placed outside the oven space (25) and the vending machine (100) is provided with drive means (27, 28) for displacing the arms (45, 46) from the first to the second position and vice versa, wherein the drive means (27, 28) are also configured to shake the food product during operation of the microwave oven and a control of the drive means (27, 28) is for this purpose such that both the first and the second arm (45, 46) move in the same direction and hold the first outer ends of the arms (45, 46) in the first position during this movement.

12. Vending machine (100) as claimed in claim 11, wherein the transport space is tubular.

13. Vending machine (100) as claimed in claim 11, wherein the first arm (45) and second arm (46) are configured to grip a cup-like container.

14. Vending machine (100) as claimed in claim 11, wherein each drive means (27, 28) is connected to a second outer end of an arm by means of a crankshaft.

15. Vending machine (100) as claimed in claim 11, wherein the at least two co-acting arms (45, 46) are displaceable between a first and a third position, wherein in the third position the first outer ends of the arms (45, 46) are placed in such proximity that the food product is fixedly clamped in the arms (45, 46).

16. Vending machine (100) as claimed in claim 11, wherein the transport space is formed by a cover (30) of microwave-permeable material which runs through the oven space (25) and extends between the entrance (102) and the exit (103).

17. Vending machine (100) as claimed in claim 11, wherein the first closing means (23) and second closing means (24) are each substantially formed by a trapezoidal plate and a collar of the same shape, which are displaceable relative to each other in the same plane.

18. Vending machine (100) as claimed in claim 11, wherein the heating device (1, 200) is provided with one or more infrared sensors for measuring the temperature of the food product during heating and shaking thereof.
